(19) United States
(12) Patent Application Publication
(10) Pub. No.: US 2009/0138277 A1
(43) Pub. Date: May 28, 2009

(54) Healthcare Transactions Management Solution

(76) Inventors: Catherine Warren, Charlotte, NC (US); Sue Spann, Duluth, GA (US); Curtis Crispin, Baltimore, MD (US); Julin Gu, Norcross, GA (US); Jennifer Lenihan, Louisville, KY (US); Clarissa McElrath, Grapevine, TX (US); Amanda Marcum, Charlotte, NC (US); Patrice Rochelle Wolfe, Bethesda, MD (US); James Bodenbender, Duluth, GA (US); Robert Wiley, Tulsa, OK (US)

Correspondence Address: BANNER & WITCOFF, LTD;ATTORNEYS FOR CLIENT NUMBER 007131, 10 SOUTH WACKER DR., SUITE 3000, CHICAGO, IL, 60606, US

(21) Appl. No.: 12/143,312

(22) Filed: Jun. 20, 2008

Related U.S. Application Data
(60) Provisional application No. 60/945,790, filed on Jun. 22, 2007.

(51) Int. Cl. G06Q 50/00; G06Q 40/00; G06Q 90/00

(52) U.S. Cl. 705/2; 705/34; 705/39

(57) ABSTRACT

Healthcare service providers and others may send claims for payment requesting remittance from insurance companies or patients. Such payments may be remitted through paper or electronic transactions. A financial institution may receive the payment and associated information and process the remittance depending on the remittance source and type. In addition, the institution may generate a single bill generated at a regular interval for the healthcare service provider for the services. The amount of the bill may be based on the volume of remittances.

### RELATED APPLICATIONS

This application claims priority from U.S. Provisional Patent Application Ser. No. 60/945,790, filed Jun. 22, 2007, entitled, “HEALTHCARE TRANSACTIONS MANAGEMENT SOLUTION.” The aforementioned provisional application is hereby incorporated by reference in its entirety.

### FIELD OF THE DISCLOSURE

Aspects of the disclosure relate to the processing of healthcare transactions. More specifically, aspects of the disclosure relate to a healthcare transactions management solution that integrates processes among the healthcare and financial industries.

### BACKGROUND

In the healthcare industry, healthcare providers and patients are faced many times with multiple bills from various vendors and/or sources for services performed and/or received. This creates, among other things, inefficiencies in patient communications, billing, and collection channels. As a result, the cost of collection is increased. In addition, there may be an increased risk of consumer receivables remaining unpaid. Moreover, such inefficiencies may result in a decreased rate of realization of revenue.

Although the Healthcare Insurance Portability and Accountability Act (HIPAA) that was enacted in 1996 has made advancements towards standardizing electronic data, there still remain many compatibility and other issues among electronic payment systems in the healthcare industry. Furthermore, many entities (e.g., healthcare providers, insurers, patients) involved in healthcare transactions continue to communicate in a non-electronic form (e.g., paper claims and payments). For example, an explanation of benefits (EOB) document is commonly provided when a payer submits funds to a payee. The EOB document can be a detailed document with a plurality of line items with sub-line items under them (and so on) itemizing the various components of a bill. In the past, funds were manually matched up to their corresponding line items in an EOB document., this process is manual and labor-intensive. In an effort to improve this process, some processing facilities used optical character recognition (OCR) technology to optically scan images of EOB documents. The data from the image file of the EOB document could be extracted and assigned to the appropriate line items and corresponding funds. Nevertheless, there exists a need in the art for a greater integration and automation of healthcare transaction processing.

### BRIEF SUMMARY

Aspects of the present disclosure address one or more of the issues mentioned above by disclosing systems, devices, and methods for a healthcare transactions management solution that integrates processes among the healthcare and financial industries. The following presents a simplified summary of the disclosure in order to provide a basic understanding of some aspects. It is not intended to identify key or critical elements of the invention or to delineate the scope of the invention. The following summary merely presents some concepts of the disclosure in a simplified form as a prelude to the more detailed description provided below.

In accordance with various aspects of the disclosure, a method is illustrated for receiving a notification of payment; generating a file corresponding to the payment; comparing the file to another file comprising claim information of a healthcare provider's accounting system; and sending an output associated with the comparing. In addition, in some examples, the output associated with the comparing may be applied to the healthcare provider's accounting system in an automated manner. Furthermore, in some examples, the method may include issuing a single fee based on a volume of remittances.

An apparatus and system for executing a method in accordance with the disclosure is also described. Such a system may comprise a processor, a memory, and a scanner. Furthermore, a tangible computer-readable medium storing computer-executable instructions that cause a processor to perform a method in accordance with the disclosure is also described.

Healthcare providers, insurance providers, patients, and other involved in the administration, remittance, and/or processing of payments of healthcare services may benefit from one or more aspects of the embodiments disclosed herein. The features of the illustrative embodiments described herein contemplate additional other embodiments comprising one or more, or a combination thereof, of the aspects described throughout.

### BRIEF DESCRIPTION OF DRAWINGS

The present disclosure is illustrated by way of example and not limited in the accompanying figures in which like reference numerals indicate similar elements and in which:

FIG. 1 depicts an illustrative personal computing device with peripheral devices in accordance with various aspects of the disclosure;

FIG. 2 shows a diagram of communications among various entities and persons in accordance with various aspects of the disclosure;

FIG. 3 shows a flowchart illustrating payment processing in accordance with various aspects of the disclosure;

FIG. 4 depicts an illustrative flowchart where a payor submits payment via paper in accordance with various aspects of the disclosure;

FIG. 5 depicts an illustrative flowchart where a payor submits payment electronically in accordance with various aspects of the disclosure;

FIG. 6 depicts an illustrative flowchart where a customer submits payment via paper in accordance with various aspects of the disclosure; and

FIG. 7 depicts an illustrative flowchart where a customer submits payment electronically in accordance with various aspects of the disclosure.

### DETAILED DESCRIPTION

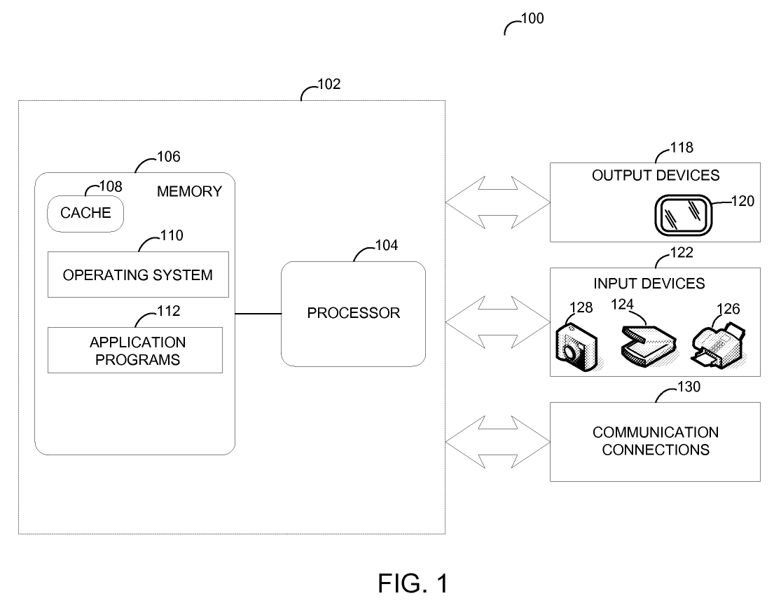

An example of an illustrative personal computing system 100 in which various aspects and embodiments of the invention may be implemented is shown in the simplified diagram in FIG. 1. The features of such a device are well-known to those of skill in the art and need not be described at length here. The illustrative system 100 is only one example of a suitable system and is not intended to suggest any limitation as to the scope of use or functionality of the invention. Suitable computing environments for use with the invention include an image processing device 102 or system that support interaction with an input devices 122 (e.g., digital camera 128, document scanner 124, multi-function office device 126, etc.), output devices 118 (e.g., visual display 120), and communication connections 130 (e.g., Ethernet connection, IEEE 802.11, dial-up connection, etc.). The communication connections 130 may be used to allow the image processing device 102 to communicate with other devices. With reference to FIG. 1, an image processing device 102 commonly includes a memory 106 and a processor 104 (e.g., an Intel microprocessor).

Programs, comprising sets of instructions and associated data, may be stored in the memory 106, from which they can be retrieved and executed by the processing unit 103. Among the programs and program modules stored in the memory 106 are those that comprise or are associated with an operating system 110 as well as application programs 112. Application programs 112, such as a web browser application, Java runtime environment, and others, and an operating system 110 are commonly installed in an image processing device 102. The memory 106 may also include a cache 106 to enhance device performance. Computing system 100 includes forms of computer-readable media. Computer-readable media include any available media that can be accessed by the image processing device 102. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

One skilled in the art will appreciate that numerous servers and/or computing devices may be used in the implementation of the various aspects of the disclosure. For example, a database may be used to maintain patient account information. In addition, data files may be stored on computer-readable medium and transported in various ways (e.g., via internet, wirelessly, wired, secure VPN, SSL, etc.) among the various devices. In addition, computer-executable instructions may be stored on computer-readable medium to perform one or more of the steps disclosed herein. A processor and/or memory, along with a user interface may be provided to interact with the various aspects of the system.

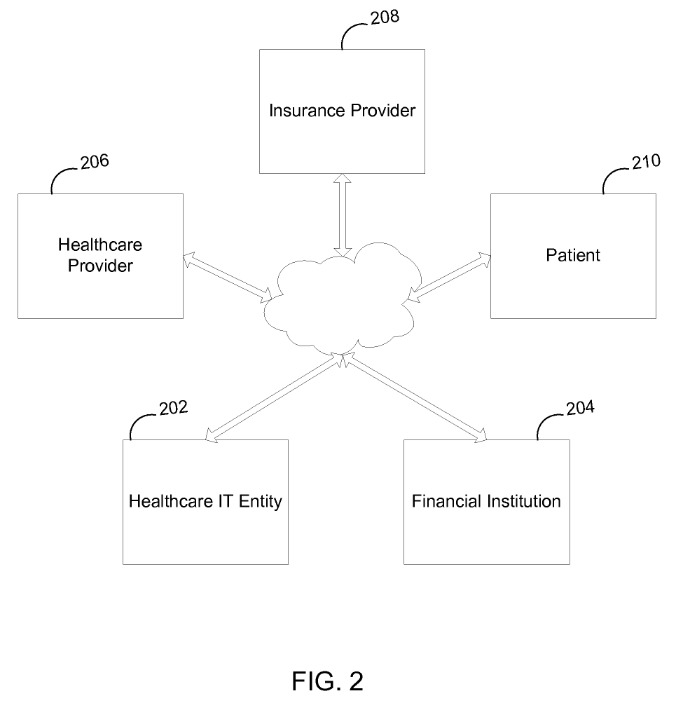

FIG. 2 depicts a simplified, illustrative diagram of communications among various entities and persons in aspects and embodiments of the disclosure. The illustrative diagram in FIG. 2 is only one example of a suitable communication scenario and is not intended to suggest any limitation as to the scope of use or functionality of the disclosure. One aspect of the disclosure teaches a solution that brings together non-financial transaction functionality of healthcare information technology (IT) companies 202 with the financial transactions of a financial institution (e.g., a bank) 204 and integrates them for the benefit of, among others, healthcare service providers 206.

The financial institution depicted in FIG. 2 may provide various services, including but not limited to, wholesale corporate and consumer lockbox, merchant services, web-based payment, EDI, and other multiple payment receivables products. The financial institution may include, among other things, an image processing device 102 comprising a memory and a processing unit that may be used to receive an image of a document such as, for example, a check or an EOB (explanation of benefits) data sheet. The memory 106 of the image processing device 102 may also include computer-executable instructions that may be executed using a processing unit (e.g., processor 104) in the image processing device. The computer-executable instructions may be used to perform a method. In various embodiments of the invention, the image processing device 102 may be a farm of computers/servers for large-scale image processing. One skilled in the art will appreciate that the image processing functionalities may required extensive processing power that a farm of servers may be ideally equipped to handle.

The healthcare IT entity 202 depicted in FIG. 2 may provide various services, including but not limited to, eligibility verification, claims submission, ERA receipt and file integration into patient accounting software, statement printing, and others. The healthcare provider 206 may maintain and designate a depository account at a financial institution 204 where credits and debits with respect to all payments, deposits, and adjustments/charges can be made.

Furthermore, patients 210 and insurance providers 208 (e.g., Medicare and commercial providers such as BlueCross BlueShield and others) may be involved in the solution, as depicted in FIG. 2. A patient may make a co-payment for a doctor's visit at the point of service (e.g., at the doctor's office). Meanwhile, the healthcare provider may submit an invoice for the remaining charges to an insurance provider for reimbursement.

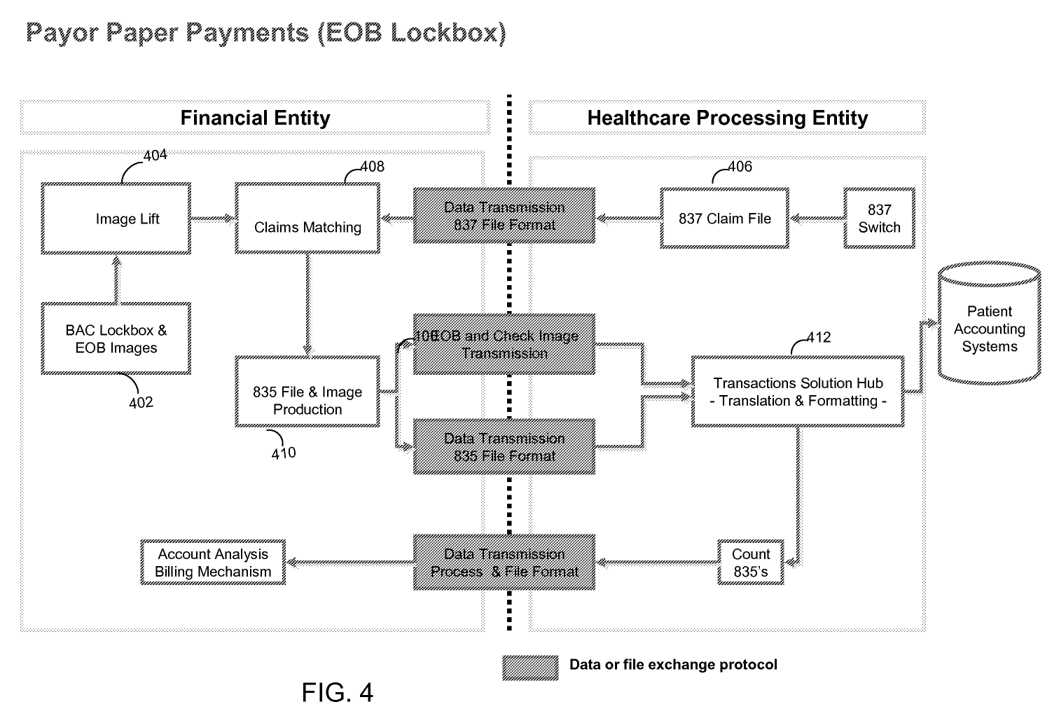

For example, in one embodiment, the solution may be implemented as a five step method. First, a healthcare provider may use a healthcare IT entity's eligibility verification service to determine if a patient that is requesting healthcare service (or has just received healthcare services) is insurance eligible or verified eligible through, among other things, a credit check. Second, the healthcare provider may submit its claims (e.g., outstanding charges) to a healthcare IT entity's claim submissions system (e.g., a claims clearinghouse). Third, the healthcare provider may use various services provided by the healthcare IT entity (or other electronic statement processing entity) and a financial institution so that the claims may be processed according to remittance source and type (e.g., paper remittance, electronic remittance, remittance by payor, remittance by consumer/patient). FIGS. 4, 5, 6, and 7 depict some details of such processing by the healthcare IT entity and financial entity. Fourth, the healthcare IT entity (or other electronic statement processing entity) may provide file delivery and integration to the healthcare provider. Finally, fifth, the healthcare provider may receive one convenient monthly bill. In one example, such a bill may be based on the volume of remittances received and a single fee may be assessed for all the functionality provided (e.g., eligibility verification, claims submission, payment processing) with the exception of pass-through fees (e.g., postage, etc.). This may be referred to as bundled pricing.

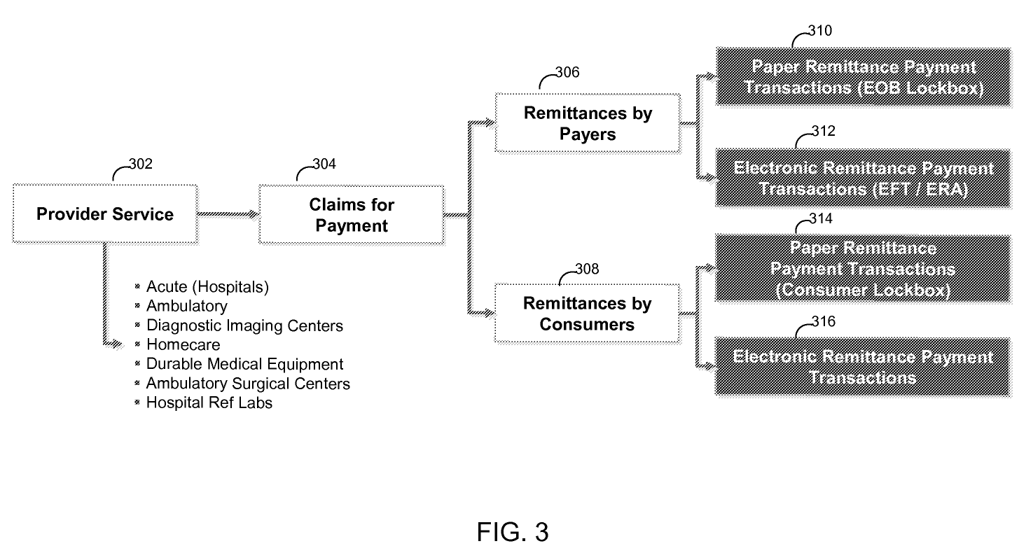

Referring to FIG. 3, various healthcare service providers 302, including but not limited to, hospitals, ambulatory care, diagnostic imaging centers, homecare, durable medical equipment, ambulatory surgical centers, hospital ref labs, and others may submit claims 304 for payment. The payments may request remittance by payors 306 (e.g., insurance company) or by consumers 308 (e.g., patients). Payors and/or consumers may remit payment through paper and/or electronic transactions. Some details about how one of skilled in the art may integrate services of a healthcare IT entity (or other electronic statement processing entity) and services of a financial entity to process payments in each of the scenarios above is described in detail.

In one example, where a payor submits payment via paper, an explanation of benefits (EOB) lockbox 310 may be used. In such an example, the following may occur: (see FIG. 4)

(1) Healthcare provider will sign up for and use a financial institution's image lockbox and data lift service 402.

a. the financial institution receives payments into the lockbox on behalf of the healthcare provider, in the form of checks, with associated paper remittance information.

b. the financial institution images checks and remittance information 404.

c. the financial institution deposits checks into depository account.

d. the financial institution creates the payment data file from the image.

(2) Healthcare IT entity delivers healthcare provider's claim file 406, or a duplicate file, (in 837 format, or other mutually agreed upon format) to the financial institution, or its designated agent.

(3) the financial institution, or its designated agent, matches 408 the claim file to the payment data file to create the file reconciled output file 410.

(4) the financial institution delivers payment data files to the healthcare IT entity in a mutually agreed upon format.

(5) The healthcare IT entity integrates payment data file into Healthcare Provider's patient accounting system 412.

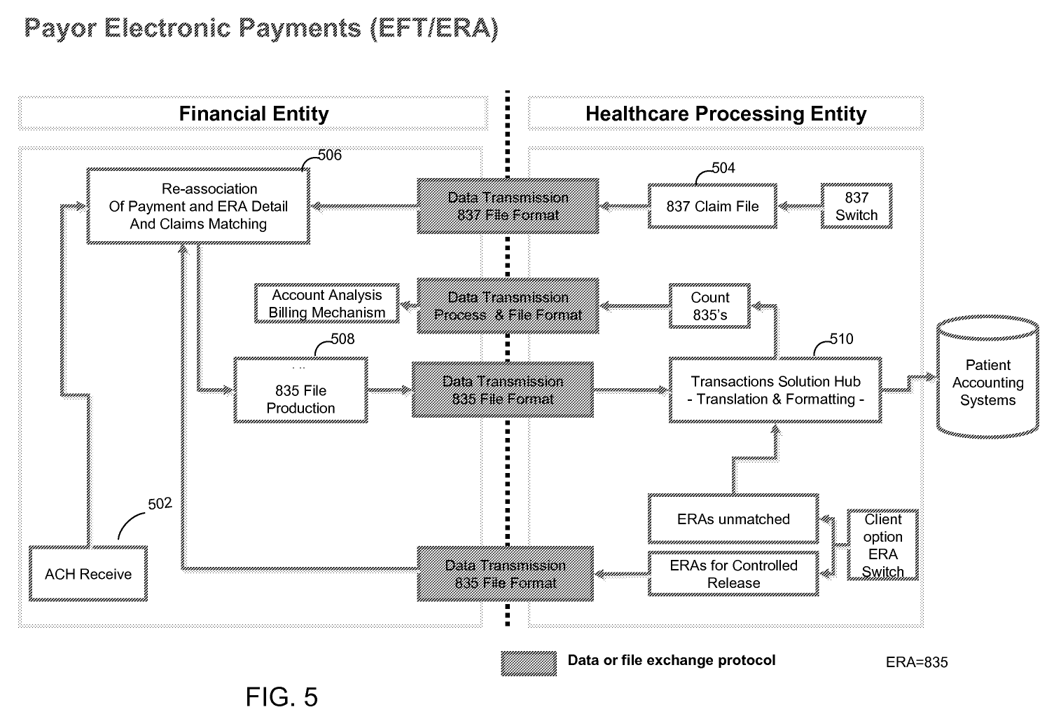

In another example, a payor submits via electronic payment and an electronic remittance advice (ERA) file 312 may be used. In such an example, the following may occur: (see FIG. 5)

(1) Healthcare provider will sign up for and use a financial institution's ACH receivables service 502.

(2) A healthcare IT entity receives healthcare provider's incoming Electronic Remittance Advice (ERA) files from payors and delivers these to the financial institution, or its designated agent.

(3) The healthcare IT entity will deliver Healthcare provider's claim file 504, or a duplicate file, (in 837 format, or other mutually agreed upon format) to the financial institution.

(4) The financial institution, or its designated agent, matches claim to payment and payment to ERA 506.

(5) The financial institution, or its designated agent, releases file to the healthcare IT entity in a mutually agreed upon format 508.

(6) The healthcare IT entity integrates ERA file into Healthcare provider's patient accounting system 510.

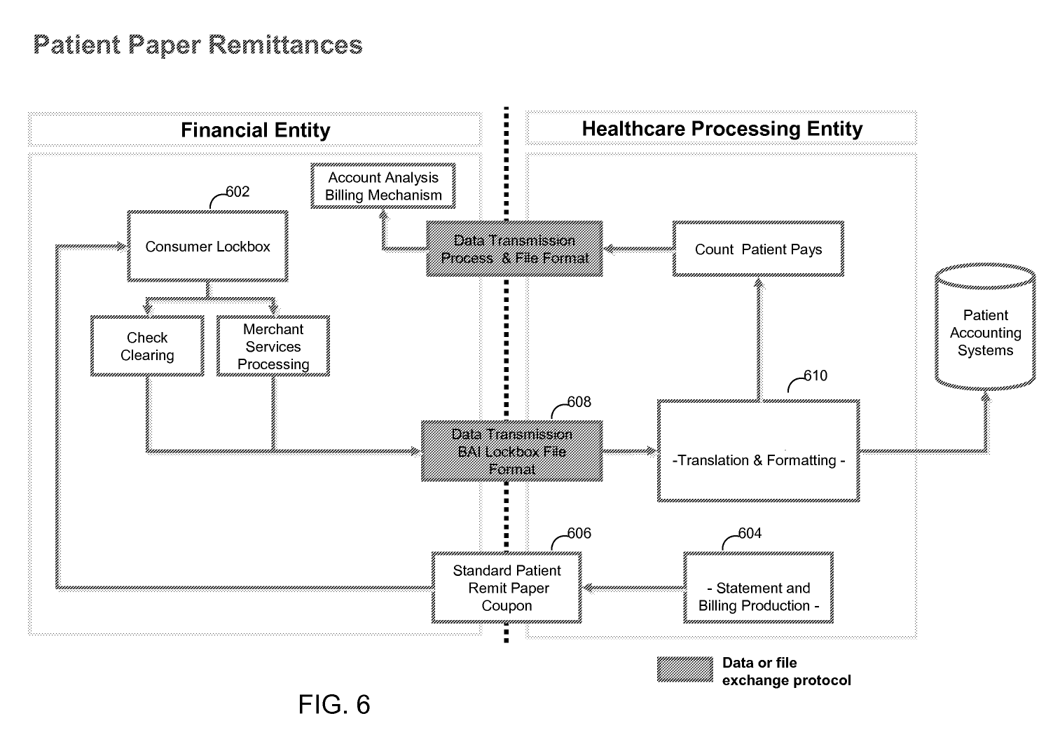

In yet another example, a consumer (e.g., patient) may submit payments via paper 314. In such an example, the following may occur: (see FIG. 6)

(1) Healthcare provider will sign up for and use a financial institution's scannable lockbox service for self-pay payments 602.

(2) Healthcare provider will sign up for and use a healthcare IT entity's (or other statement processing entity's) software system for statement printing 604.

(3) The healthcare IT entity (or other statement processing entity) formats statement coupon to meet the financial institution's lockbox requirements 606.

(4). The financial institution receives patient payments into the lockbox on behalf of Healthcare provider, in the form of checks, or credit/debit card numbers, with associated scanable coupon. For example, the coupon may be scanable by means of a bar code (or some other scanable line or area) on the coupon.

a. The financial institution images checks and scans coupon information, or

b. The financial institution authorizes card payment and scans coupon information

c. The financial institution deposits payments into depository account.

(5) The financial institution will send lockbox file to healthcare IT entity in a predetermined format (e.g., Bank Administration Institute format) 608.

(6) The healthcare IT entity integrates the formatted file into Healthcare provider's patient accounting system 610.

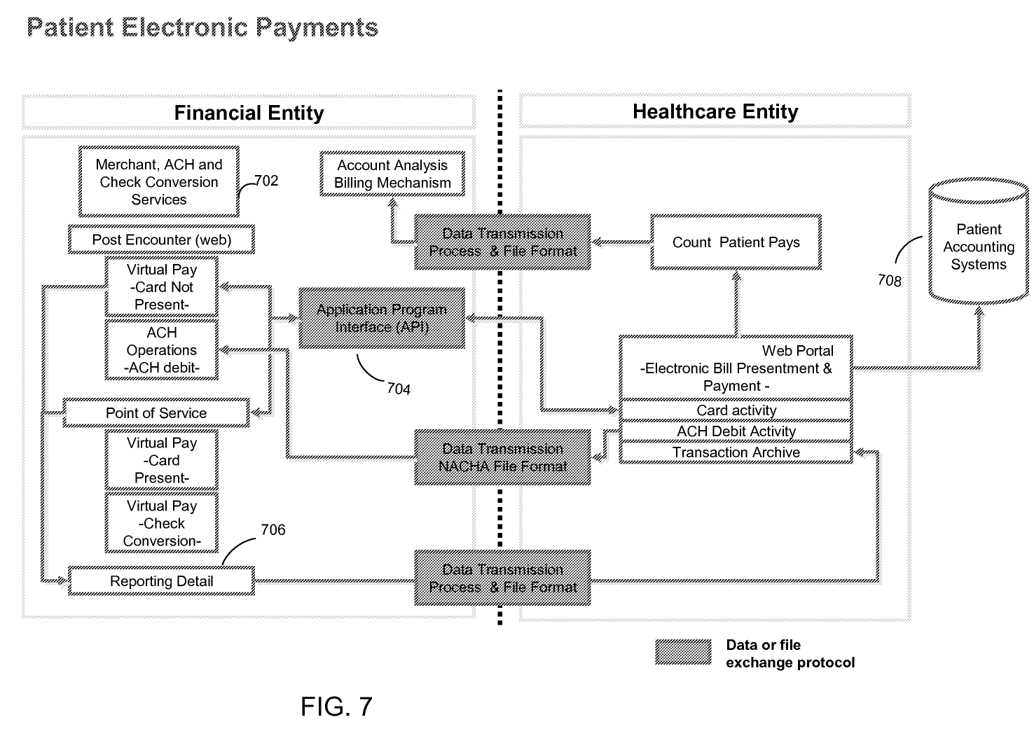

In another example, a consumer (e.g., patient) submits via electronic payment 316. In some instances, the patient may use a web-based portal to submit payments electronically over the Internet. In such an example, the following may occur: (see FIG. 7)

(1) Healthcare provider will enter into a merchant services agreement with a financial institution 702.

(2) Healthcare provider implements healthcare IT entity's software system 704.

(3) The healthcare IT entity will deliver merchant transactions created on its software system to the financial institution for processing on behalf of Healthcare provider(s).

(4) The healthcare IT entity will deliver a file of automated clearinghouse transactions created on the healthcare IT entity's software system to the financial institution for processing on behalf of Healthcare provider(s).

(5) The financial institution's merchant services will deliver reporting to the healthcare IT entity to the extent permitted by applicable associations (e.g., Visa, MasterCard, American Express, Discover, NACHA) Operating Rules and Regulations and the financial institution's privacy policy 706.

(6) The healthcare IT entity integrates file into Healthcare provider's patient accounting system 708.

In accordance with various aspects of the disclosure, a patient may go to a hospital (or other healthcare provider) for some form of treatment. When the patient arrives at the hospital, the hospital may ask if the patient has insurance coverage. If the patient has insurance coverage, the healthcare provider (abbreviated “HP”) may ask for the patient's insurance card to verify eligibility. The HP may use a healthcare IT entity (or other entity) to perform verification services. However, if the patient does not have eligible insurance, the HP may submit a request for eligibility verification services to ensure that the patient will be able to pay. The verification may include, but is not limited to, a demographic check (e.g., verify that the home address is correct), credit check (e.g., obtain a FICO score), and charity eligibility (i.e., whether the patient's income level meets the poverty level requirements for assistance). Assuming such verification results positive results, the healthcare provider will provide services to the patient and provide the patient with an invoice at the time of treatment or at a later date.

Assuming the scenario where the patient has verifiable insurance coverage, the patient may be asked to pay a co-pay (e.g., a $50 co-payment for each visit) at the point and time of treatment. The HP may collect such a co-pay at the point of service (POS). The HP may enter the co-pay amount and related information into a patient accounting system. Then later (e.g., over the next 30 days), the HP may request that an invoice detailing all the services performed and items provided (e.g., the invoice may list the physician's that saw the patient, the x-rays that were taken, the MRI technician, the radiologist's bill, the aspirin and other medications provided, the anesthesiologist, etc.) be generated. The invoice (or claim) may be sent to a healthcare IT entity (or other processing entity) where it is processed and sent to an insurance provider for review and remittance. A claims clearinghouse at the healthcare IT entity (or other processing entity) may be used to, among other things, process and forward the claim to the appropriate entity.

Once the claim is received by the insurance company, the insurance company may either pay or deny payment. If the insurance company's response includes a payment, then they may pay via electronic means (see FIG. 5) or paper means (see FIG. 4).

If payment is via paper (e.g., a paper check and a paper explanation of benefits/payments (EOB/EOP) of what they are paying—“We're paying 80% percent of the radiologist's bill and we are paying 70% percent of the MRI, etc.”), then the paper is processed through a financial institution's lockbox. The financial institution may process the check and almost immediately deposit the amount to the healthcare provider's account. The financial institution may also process the EOB/EOP by scanning an image of the paper and attempting to convert (e.g., using optical character recognition (OCR)) any information on the paper into an electronic data file. The data file may be in an industry-standard HIPAA-compliant format (e.g., 835 format) or any other appropriate predetermined format. The financial institution may send the aforementioned electronic data file to a healthcare IT entity.

The healthcare IT entity (or other processing entity) may use the information in the electronic data file to identify what amount was paid and where the amount should be applied against the outstanding claim/invoice. In some examples, the electronic data file may be sent to the healthcare provider for their systems so that the healthcare provider can match up the credit in their deposit account to the appropriate claim (and line items in that claim).

Alternatively, if the insurance company's response includes a payment in electronic form (see FIG. 5), then the information transmitted may be an actual electronic data file comprising, in some embodiments, of two parts (or of two separate associated files). One part of the data file may be the EFT (electronic file transfer) portion/file that corresponds to the transfer of money in the account (e.g., as with an ACH file). The EFT/ACH portion may contain little data aside from conveying what the payment is for and a reference identifier to link the two files (or parts of the file). For example, the EFT/ACH file/portion may explain that a payment of $20,000 for the patient's treatment is to be applied towards the invoice/claim in a certain way (e.g., “paying 80% percent of the radiologist's bill and paying 70% percent of the MRI, etc.”). The other part of the data file may be an ERA (electronic remittance advice) portion/file corresponds to the EOB/EOP that provides information about the detailed line items in an invoice. The ERA file/portion may be sent to a healthcare IT entity (e.g., claims clearinghouse) and the EFT file/portion may be sent to a financial institution.

Next, the healthcare IT entity may send the ERA file to the financial institution for additional processing and manipulation. The financial institution may match the payments listed on the ACH file with the appropriate line items in the ERA file. Using the example of earlier, as such, the explanation of the $20,000 payment is associated to that specific $20,000 payment. The financial institution may adjust (e.g., augment) the ERA file with the additional information and return it to the healthcare IT entity. As such, the healthcare IT entity has an enhanced ERA file with additional information explaining the specific payment and may deliver the enhanced information to the healthcare provider. As a result, the healthcare IT entity may have two different types of incoming payment streams. For example, one may be an electronic payment stream from a large insurance provider with electronic capabilities. The second being an electronic incoming data stream from the financial institution comprising the paper payment stream from smaller insurance providers without ready access to electronic capabilities. As such the healthcare IT entity (or other statement processing entity) may store in its database (e.g., at the clearinghouse) all the paper and electronic payment information.

Furthermore, regarding FIG. 5, the healthcare provider may be provided with an option (e.g., a client option ERA switch”) for deciding whether it wants to wait to receive the ERA data file until only after payment has been credited to their account, or whether it wants to receive the ERA before receipt of payment is certain. One skilled in the art will appreciate that healthcare provider with different mindsets and operations may prefer one option over the other. Such an option may be set to a predetermined setting that may be adjusted upon request.

Meanwhile, referring to FIG. 6 and FIG. 7, a patient may also remit via paper or electronic channels. The financial institution may be provided with all the outstanding invoices which details all the services and/or items provided to patients during their visit to the healthcare provider. In one example, the healthcare IT entity (or other statement processing entity) may send an electronic data file with the details of the open invoices/claims to the financial institution. Alternatively, the electronic data files may be coming in from an electronic payer. In yet another embodiment, the electronic data files may be created by scanning a paper EOB. The financial institution may actually match the open invoice file against incoming payments (both electronic and paper) and augment the data in the electronic data file (e.g., ERA file). Thus, the system is able to match the incoming funds against the open claims file to confirm that every line item associated with a patient's service of care is matched. The enhanced file sent back to the healthcare IT entity contains a comprehensive, robust re-associated reconciled file for delivery to a healthcare provider. The healthcare provider may apply the data file to their patient accounting system in an automated manner; thus, eliminating the need for inefficient manual entry of the data into the various systems.

One skilled in the art will appreciate that in some examples, the data file may be modified slightly to accommodate a particular healthcare provider's particular patient accounting system. However, in many instances the data may be applied in an automated manner without additional manipulation. In other instances the healthcare IT entity may modify the data file according to known patient accounting systems at various healthcare providers and transmit the data file in the appropriate format.

Assuming the insurance provider pays, for example, $20,000 of the patient's $25,000 invoice, the patient accounting system may generate a statement/invoice for delivery to the patient for payment. In some instances the healthcare IT entity (or other statement processing entity) may provide such services on behalf of the healthcare provider. The statement may be delivered in paper format (e.g., through regular mail) or through the Internet (e.g., through a network interface). The statement may include a coupon that is appropriately designed to meet the requirements for a financial institution's scannable lock-box. The patient may enclose the coupon when submitting payment. The coupon may include a bar code (or other scanable area) designed to convey information in an encrypted (or unencrypted) format. The financial institution may scan, using various techniques, the coupon to identify the appropriate patient information and generate a data file that includes such information, including for example, the patient account number and invoice amount. Such a data file may be sent to the healthcare IT entity (or other statement processing entity) for additional processing or routing. As such, a patient accounting system may post the amount against the correct outstanding patient invoice.

If the patient elects to pay electronically (e.g., online), the patient may pay using a web-based portal system. The system may collect the appropriate information and act as a third-party processor for the merchant side. It may batch up the ACH transactions and deliver them at a regular interval (e.g., daily, or in realtime) to the financial institution for processing. The financial institution may then deliver the posting confirmation to the portal. As such, all entities involved in the transaction (e.g., hospitals, etc.) are notified that a payment has been posted.

The financial institution may also deliver all associated image files and other files to the healthcare IT entity (or other statement processing entity) for aggregation and calculation of fees. In one example, the single fee (e.g., bundled pricing) may be calculated based on the total number of transactions. As such, the healthcare provider may pay a single fee in lieu of multiple fees to multiple vendors. Thus, enhancing the providers ability to manage fees. The financial institution may bill the client (e.g., automatically withdraw the proper fees) from the healthcare provider's account.

Although not required, one of ordinary skill in the art will appreciate that various aspects described herein may be embodied as a method, a data processing system, or as a computer-readable medium storing computer-executable instructions. For example, a computer-readable medium storing instructions to cause a processor in a computing device to perform steps of a method in accordance with aspects of the disclosure is contemplated. In addition, various signals representing data or events as described herein may be transferred between a source and a destination in the form of electromagnetic waves traveling through signal-conducting media such as metal wires, optical fibers, and/or wireless transmission media (e.g., air and/or space).

Aspects of the invention have been described in terms of illustrative embodiments thereof Numerous other embodiments, modifications and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. Furthermore, the features of the embodiments described above contemplate other embodiments comprising one or more, or a combination thereof, of the aspects described throughout.

I claim:

1. A computer-assisted method comprising:
receiving a notification of payment;
generating a first file corresponding to the payment, the first file comprising claim information;
comparing the first file to a second file using a computer, the second file comprising claim information of a healthcare provider's accounting system;
generating an output associated with the comparing;
integrating the output associated with the comparing and outputs from a plurality of payment sources into a file with a predetermined format;
sending the file to the healthcare provider's accounting system; and
issuing a single fee per remittance.

2. The method of claim 1, further comprising: sending the file to a healthcare information technology entity.

3. The method of claim 1, where generating the first file includes receiving an electronic remittance advice file.

4. The method of claim 1, where the receiving the notification of payment comprises receiving a paper check, the method further comprising:
receiving paper remittance information associated with the paper check.

5. The method of claim 1, where the receiving the notification of payment comprises receiving a paper check, the method further comprising:
receiving a formatted payment coupon associated with the paper check.

6. The method of claim 5, where the formatted payment coupon comprises account number, healthcare provider identification, and invoice amount.

7. The method of claim 1, further comprising:
applying the file to the healthcare provider's accounting system in an automated manner.

8. A tangible computer-readable medium storing computer-executable instructions configured to cause a processor to perform a method comprising:
receiving a notification of payment;
generating a first file corresponding to the payment, the first file comprising claim information;
comparing the first file to a second file using a computer, the second file comprising claim information of a healthcare provider's accounting system;
generating an output associated with the comparing;
integrating the output associated with the comparing and outputs from a plurality of payment sources into a file with a predetermined format;
sending the file to the healthcare provider's accounting system; and
issuing a single fee per remittance.

9. The computer-readable medium of claim 8, where the receiving the notification of payment comprises receiving an image of a paper check, the method further comprising:
receiving paper remittance information associated with the paper check, where the paper remittance information includes an image of an explanation of benefits document.

10. The computer-readable medium of claim 8, where the receiving the notification of payment comprises receiving an image of a paper check, the method further comprising:
receiving an image of a formatted payment coupon associated with the paper check, the image comprising claim information.

11. The method of claim 10, where the image of the formatted payment coupon comprises account number, healthcare provider identification, and invoice amount.

12. A system, comprising:
a processor; and
a memory storing computer-executable instructions configured to cause the processor to perform a method comprising:
receiving a notification of payment;
generating a first file corresponding to the payment, the first file comprising claim information;
comparing the first file to a second file using a computer, the second file comprising claim information of a healthcare provider's accounting system;
generating an output associated with the comparing;
integrating the output associated with the comparing and outputs from a plurality of payment sources into a file with a predetermined format;
sending the file to the healthcare provider's accounting system; and
issuing a single fee per remittance.

13. The system of claim 12, further comprising a scanner and computer-executable instructions configured to cause the processor to receive paper remittance information associated with a paper check, where the paper remittance information includes an image of an explanation of benefits document

14. The system of claim 13, further comprising computer-executable instructions configured to cause the processor to perform optical character recognition on the image of the explanation of benefits document.

15. The system of claim 12, further comprising a scanner and computer-executable instructions configured to cause the processor to receive an image of a formatted payment coupon associated with a paper check, the image comprising a scanable area encoding claim information.
